(19) United States
(12) Patent Application Publication
(10) Pub. No.: US 2024/0180331 A1
(43) Pub. Date: Jun. 6, 2024

(54) REMOTE CONTROL DEVICE

(71) Applicant: KOBELCO CONSTRUCTION MACHINERY CO., LTD., HIROSHIMA-SHI, HIROSHIMA (JP)

(72) Inventors: Masaki OTANI, HIROSHIMA-SHI, HIROSHIMA (JP); Hitoshi SASAKI, SHINAGAWA-KU, TOKYO (JP); Yoichiro YAMAZAKI, SHINAGAWA-KU, TOKYO (JP)

(21) Appl. No.: 18/576,276

(22) PCT Filed: Apr. 27, 2022
(86) PCT No.: PCT/JP2022/019026

§ 371 Date: Jan. 3, 2024

(30) Foreign Application Priority Data
Jul. 15, 2021 (JP) 2021-117373

(51) Int. Cl. A47C 1/00; E02F 9/20

(52) U.S. Cl. CPC A47C 1/00; E02F 9/205

(57) ABSTRACT

An object of the present invention is to provide a remote control device which is easy to get on and off and further to provide a remote control device which is easy to get on and off without having a firm foot retainment portion. A remote control device includes a seat device 40 and operates a machine by a remote operation, and the remote control device includes an operation mode which is for an operator to operate the machine and a getting on-off mode which is for the operator to get on and off the seat device 40. In the getting on-off mode, at least a part of the seat device 40 is positioned closer to a floor compared to the operation mode.

### TECHNICAL FIELD

The present invention relates to a remote control device which remotely operates a vehicle based on an operation by an operator.

### BACKGROUND ART

In related art, as disclosed in Patent Literature 1, a remote control device has been known which remotely operates a work machine. Outside environment sensors such as a slave-side operation device and a camera are attached to the work machine of Patent Literature 1, and an operator can ride the remote control device and perform a remote operation while viewing an outside situation of an actual machine, which is shown by a display.

Further, as a technique related to a remote control device and a method for reproducing a sense of presence in riding an actual machine, a method has been discussed in which vibration of the actual machine in work and rotation of an upper revolving body of the actual machine are detected and transmitted to the remote control device and the remote control device thereby reproduces motions of a cabin to be experienced in riding the actual machine.

In a case of the above remote control device, a seat device which the operator rides is configured to be capable of vibrating and rotating, and configured with a foot retainment portion which is for a foot to be placed. The foot retainment portion has to be arranged in a position higher than a floor such that the foot retainment portion does not interfere with the floor. In the remote control device configured in such a manner, the operator can perform a remote operation with a feeling close to a feeling in riding the actual machine by using a camera image on the display and the motions of the seat device.

### CITATION LIST

### Patent Literature

Patent Literature 1: Japanese Patent Laid-Open No. 2020-154851

### SUMMARY OF INVENTION

### Technical Problem

However, when a foot retainment portion is arranged in a high position from a floor, it becomes difficult to get on and off a seat device. Further, in a case where the foot retainment portion has a structure in which the foot retainment portion is arranged high from the floor, the foot retainment portion has to have a firm structure to prevent deformation due to body weight when getting on and off, which increases weight and manufacturing cost. In addition, it is important that the remote control device can be remotely operated safely and efficiently.

To solve the above circumstance, an object of the present invention is to realize a remote control device which is easy to get on and off. In addition, an object is to provide a remote control device which enables getting on and off without having a firm foot retainment portion and which can be remotely operated safely and efficiently.

### Solution to Problem

A remote control device according to the present invention includes: an operation mode which accepts an operation of a machine by an operator, and a getting on-off mode which is for the operator to get on and off a seat device, and in the getting on-off mode, at least a part of the seat device is positioned closer to a floor compared to the operation mode.

### BRIEF DESCRIPTION OF DRAWINGS

FIG. 1 is a perspective view of a remote control device according to an embodiment of the present invention.

FIG. 2 is a side view illustrating a getting on-off mode state of the remote control device in FIG. 1.

FIG. 3 is a side view illustrating a standby mode state of the remote control device in FIG. 1.

FIG. 4 is a side view illustrating an operation mode state of the remote control device in FIG. 1.

FIG. 5 is an enlarged side view illustrating a driving device peripheral portion of the remote control device in FIG. 1.

FIG. 6 is a perspective view illustrating a first up-down direction driving unit along a B-B cross-section in FIG. 1.

### DESCRIPTION OF EMBODIMENT

### Embodiment

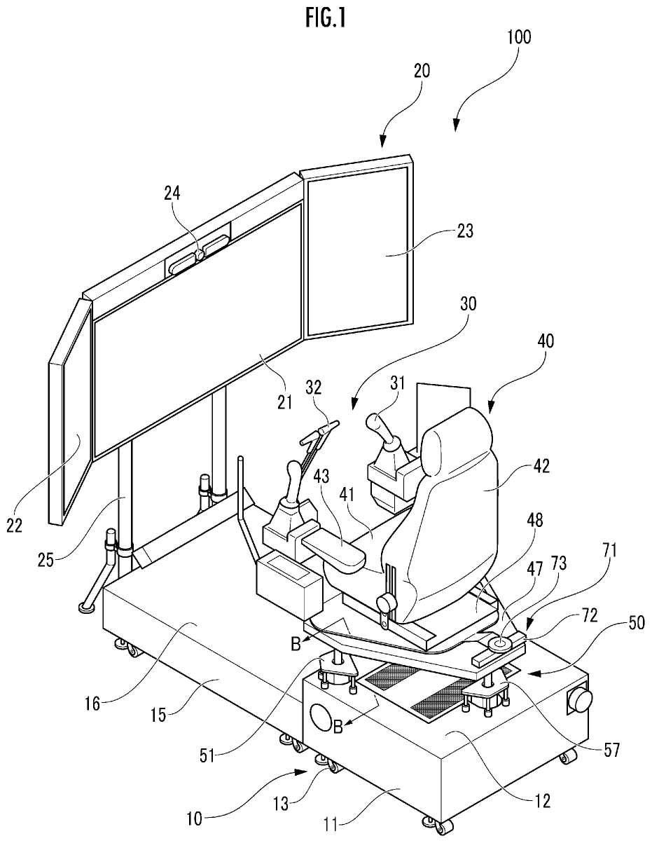

A remote control device 100 according to the present invention will be described with reference to FIG. 1. The remote control device 100 is a device for remotely operating a machine, which is not illustrated and is present in a place away from the remote control device 100. Although a kind of the machine is not limited, the machine is a crawler excavator of a work machine, for example.

The crawler excavator includes a crawler type lower traveling body and an upper revolving body which is mounted on the lower traveling body via a revolution mechanism. The upper revolving body is provided with a cab and a work attachment which includes an arm having a bucket. The cab is provided with a control mechanism which is capable of remotely operating operation levers and so forth and an image-capturing device which captures an image of an ambient environment through a front window of the cab. An image captured by the image-capturing device is wirelessly transmitted to the remote control device 100, and an operator can thereby visually recognize a captured image. The operator operates the remote control device 100 while viewing a transmitted image, a control signal is transmitted from the remote control device 100, and the work machine is thereby remotely operated. An acceleration sensor such as a gyro-sensor which detects accelerations in three-axis directions is mounted on the work machine, and an acceleration signal detected by the acceleration sensor is wirelessly transmitted to the remote control device 100.

The remote control device 100 includes a housing 10, a monitor device 20 which shows an image of an ambient environment of a machine to be remotely operated, an operation device 30 which generates an operation signal, a seat device 40 which is arranged on the housing 10, and a driving device 50 which drives the seat device 40.

The housing 10 is a member to whose upper portion the seat device 40 is fixed and which houses electronic apparatuses in an internal portion. In order to enhance transportability of the remote control device 100, the housing 10 is configured with plural portions and has a first housing portion 11 and a second housing portion 15. The first housing portion 11 and the second housing portion 15 are respectively formed into rectangular cuboids and are formed to have the same left-right direction lengths, different front-rear direction lengths, and different up-down direction lengths. The second housing portion 15 is arranged in contact with a front side of the first housing portion 11, and in four corners of their respective side surfaces which are in contact with each other, the first housing portion 11 and the second housing portion 15 are connected together by fastening tools such as bolts and nuts which are not illustrated. In a lower surface of each of the first housing portion 11 and the second housing portion 15, plural casters 13 including movement prevention tools are arranged. Note that in transportation, the first housing portion 11 and the second housing portion 15 are easily separable from each other by detaching the fastening tools fixing those together.

The second housing portion 15 is formed to have a long front-rear direction length and a short up-down direction length compared to the first housing portion 11. The first housing portion 11 has a first upper plate 12 in an upper surface of the first housing portion 11. Further, the second housing portion 15 has a second upper plate 16 in an upper surface of the second housing portion 15. A height of the second upper plate 16 is set lower than a height of the first upper plate 12. In a case where the operator rides the remote control device 100, it becomes more difficult to get on and off as the seat device 40 becomes higher, but the second housing portion 15 is made lower than the first housing portion 11, and the second housing portion 15 can thereby be used as a step ladder for getting on and off. Together with the seat device 40 which moves upward and downward in getting on and off, the second housing portion 15 realizes the remote control device 100 which is easy to get on and off.

In an internal portion of the first housing portion 11, a first arithmetic processing unit, a second arithmetic processing unit, and a seat controller are housed which are not illustrated and are the electronic apparatuses. The first arithmetic processing unit performs output control of the monitor device 20 and recognition of various inputs including inputs from operation levers 31 and traveling levers 32. The second arithmetic processing unit manages communication between the remote control device 100 and a work machine to be a remote operation target, hands over an image and a signal about an inclination, which are wirelessly transmitted from the work machine, to the first arithmetic processing unit, and transmits input information such as an operation input, which is recognized by the first arithmetic processing unit, to the work machine. The seat controller controls the driving device 50 based on the acceleration signal received by the remote control device 100.

In an internal portion of the second housing portion 15, a communication device is housed which is not illustrated and is the electronic apparatus. The communication device is a device, which performs communication with the work machine as the target of the remote operation, and is controlled by the second arithmetic processing unit. The communication device is configured with a transmission-reception unit and a switching hub which connects the transmission-reception unit with other control apparatuses such as the first arithmetic processing unit and the second arithmetic processing unit. The communication device and the other control apparatuses are connected with each other by LAN cables, for example.

Next, the monitor device 20 will be described. The monitor device 20 has a central monitor 21, a left monitor 22, a right monitor 23, an image-capturing device 24 which is provided to an upper portion of the central monitor 21, and monitor support portions 25 which support the central monitor 21 and so forth. The monitor device 20 displays images of a front area of the work machine and its left and right areas, the images being transmitted from the work machine. The operator remotely operates the work machine while viewing the images on the monitor device 20. The monitor support portion 25 is formed with a hollow pipe formed of metal. Two monitor support portions 25 are arranged to be parallel with each other and to be perpendicular to an installation surface on which the remote control device 100 is installed. The central monitor 21 is arranged to be spanned across the two monitor support portions 25 in respective upper portions of the monitor support portions 25, and the central monitor 21 is fixed to the two monitor support portions 25 on a back surface of the central monitor 21. The left monitor 22 and the right monitor 23 are respectively retained by opening-closing devices, which are not illustrated, on a left side and a right side of the central monitor 21 and can be opened and closed relatively to the central monitor 21 while the opening-closing devices are used as centers.

Respective lower end portions of the monitor support portions 25 are fixed to a perpendicular surface on a front side of the second housing portion 15. Because the monitor support portions 25 are fixed to predetermined positions of the second housing portion 15, when the remote control device 100 is transported and the remote control device 100 is thereafter assembled, the monitor device 20 does not have to be matched with a predetermined position by, every time, adjusting a space between the seat device 40 and the monitor device 20, and assembly is completed in a state where a predetermined space is set. Note that fixing tools which fix the monitor device 20 to the monitor support portions 25 are not particularly limited but may be fastening tools which are formed with a metal bracket formed into a U shape, bolts, nuts, and so forth, for example. By using the fastening tools of the metal bracket, the bolts, and the nuts, the remote control device 100 can easily be disassembled and assembled.

The seat device 40 is arranged on the first housing portion 11. The seat device 40 has a seat portion 41, a backrest portion 42, armrests 43, a foot retainment portion 44, a first support plate 47, and a second support plate 48.

The operator is seated on the seat portion 41 and performs the remote operation in a state where his/her back is supported by the backrest portion 42. The armrests 43, 43 are respectively fixed to left and right areas of the seat portion 41. The foot retainment portion 44 is a member which is for a foot to be placed when the work machine is remotely operated, and is fixed to the second support plate 48, which is rotatably supported by the first support plate 47. The operation device 30 includes operation levers 31 for operating the arm or the like of the work machine and traveling levers 32 for operating a traveling device. The operation levers 31, 31 are respectively arranged in the left and right armrests 43, 43. Further, the traveling levers 32 are arranged in the foot retainment portion 44.

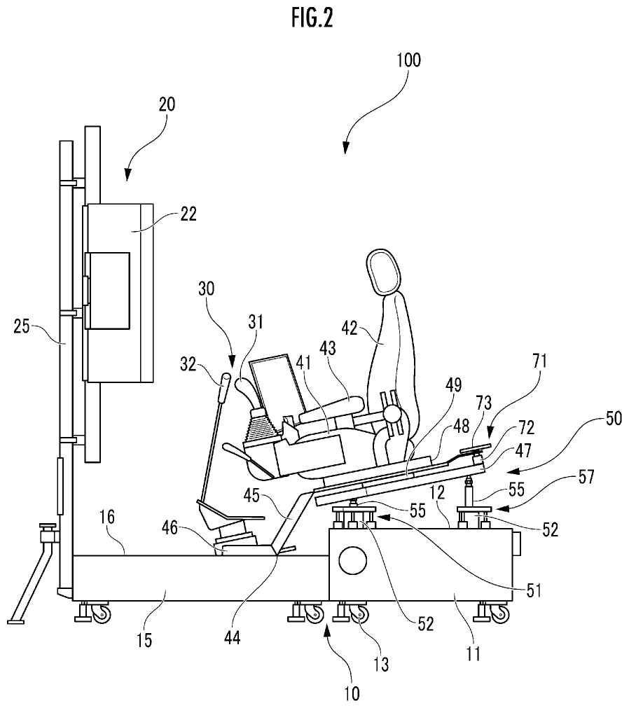

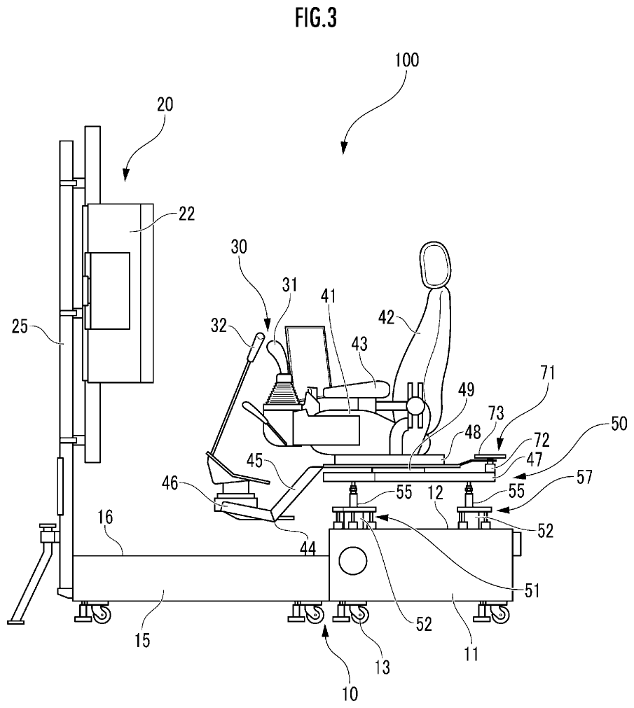

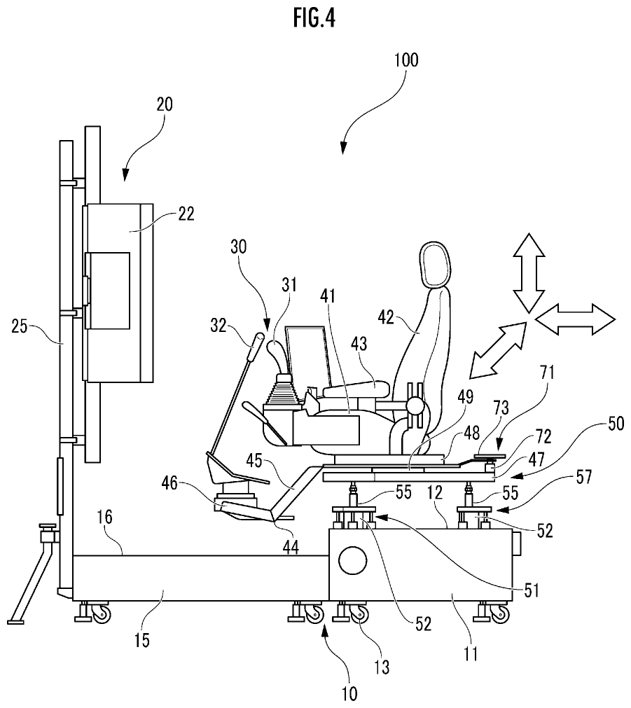

A support structure of the seat device 40 will be described with reference to FIG. 2 to FIG. 4. FIG. 2 illustrates the remote control device 100 in a getting on-off mode state in a case where the operator gets on and off. Note that FIG. 3 illustrates the remote control device 100 in a standby mode state to which a transition is made after a getting on-off mode, and FIG. 4 illustrates the remote control device 100 in an operation mode state in which the work machine is capable of being remotely operated. A description will later be made about details of control in each mode in FIG. 2 to FIG. 4 and actions of the seat device 40.

The driving device 50 has first up-down direction driving units 51 and a second up-down direction driving unit 57, which cause the seat device 40 to move upward and downward and to vibrate, and a rotation direction driving unit 71, which rotates the seat device 40.

The seat device 40 is supported by the first up-down direction driving units 51, 51 and the second up-down direction driving unit 57, each of which is arranged in an upper portion of the first housing portion 11. Two first up-down direction driving units 51, 51, which are arranged on a front side of the upper portion of the first housing portion 11, and one second up-down direction driving unit 57, which is arranged on a rear side of the upper portion of the first housing portion 11, are respectively arranged in positions of vertices of a virtual triangle in a top view. As for those positions, in a case of assuming that a virtual triangle, in which one side arranged in parallel with a left-right direction of the remote control device 100 is arranged on a front side, is present on the first upper plate 12 of the first housing portion 11, the first up-down direction driving units 51, 51 are arranged in the respective positions of the two vertices on the front side of the virtual triangle, and the second up-down direction driving unit 57 is arranged in the position of the vertex on a rear side.

Above the first up-down direction driving units 51, 51 and the second up-down direction driving unit 57, the first support plate 47 is fixed while being connected with each of the first up-down direction driving units 51, 51 and the second up-down direction driving unit 57. As illustrated in FIG. 1, the first support plate 47 is a plate member, is formed into a general triangle in which one side positioned in parallel with the left-right direction is arranged on a front side, and is formed into a shape in which a vertex on a rear side is cut off'by a straight line parallel with the one side on the front side.

On the first support plate 47, the second support plate 48 is placed in a rotatable state via a rotation retainment device 49. The second support plate 48 is a plate member formed into a rectangular shape in which a front-rear direction length is slightly longer than a left-right direction length, and the seat portion 41 is fixed to an upper surface. The rotation retainment device 49 is arranged in the vicinity of a general center of an upper surface of the first support plate 47. The rotation retainment device 49 supports the vicinity of a general center of a lower surface of the second support plate 48 such that the second support plate 48 is rotatable relatively to the first support plate 47. The foot retainment portion 44 has a first foot retainment member 45 which is fixed to the second support plate 48 and a second foot retainment member 46 which is connected with the first foot retainment member 45 and is a member for a foot to be placed. The second support plate 48, the seat portion 41, the backrest portion 42, and the foot retainment portion 44 are supported to be integrally rotatable relatively to the first support plate 47 while the rotation retainment device 49 is used as a rotation center.

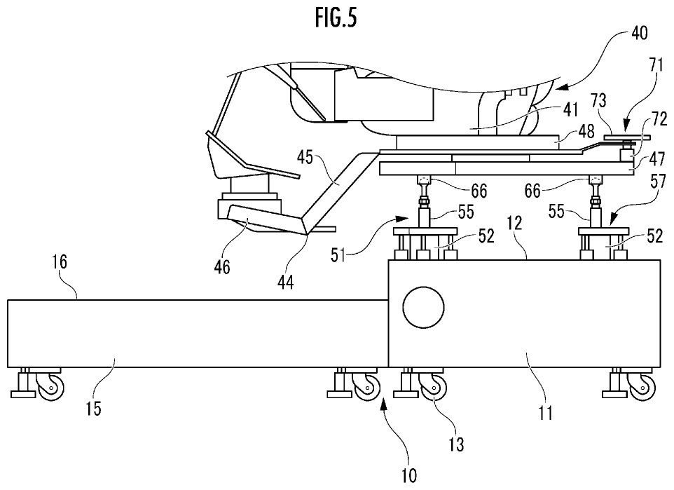

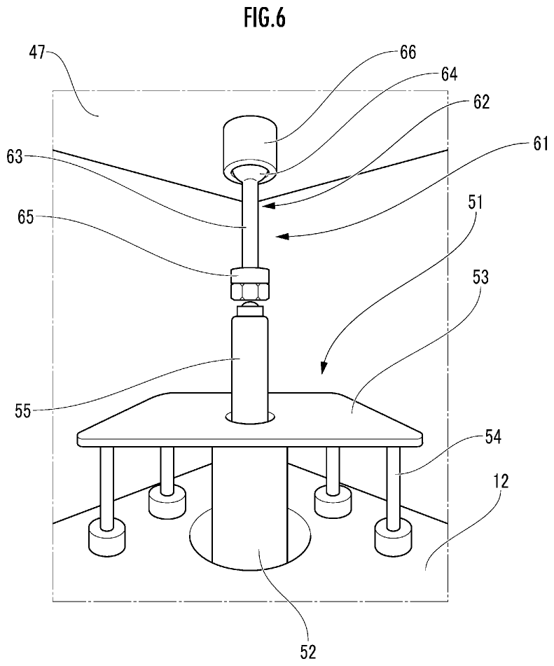

The driving device 50 will be described with reference to FIG. 5 to FIG. 6. FIG. 5 is an enlarged view of the driving device 50. FIG. 6 illustrates the first up-down direction driving unit 51 along a B-B cross-section in FIG. 1. The first up-down direction driving units 51, 51 and the second up-down direction driving unit 57, which support the seat device 40 from a lower side, drive the seat device 40 in the up-down direction. Further, the rotation direction driving unit 71 arranged on the upper surface of the first support plate 47 drives the seat device 40 in a rotation direction.

First, a description will be made about the first up-down direction driving units 51, 51 and the second up-down direction driving unit 57, which are mechanisms causing the seat device 40 to move upward and downward. The first up-down direction driving units 51, 51 and the second up-down direction driving unit 57 are the same units, and each of those has an outer tube 52, an inner tube 55, and a ball joint 61.

In each of predetermined positions in a total of three parts of the first housing portion 11, the outer tube 52 is fixed while its lower end portion is inserted in an internal portion of a fixing hole provided to the first housing portion 11 and while its upper end portion is exposed on the first upper plate 12 of the first housing portion 11. The outer tube 52 has a fixing plate 53 and a fixing tool 54. As for the outer tube 52, a general central portion of a lower surface of the fixing plate 53 is, from an upper side, pushed onto the upper end portion of the outer tube 52. Four fixing tools 54 are downward provided to the fixing plate 53 so as to surround the outer tube 52 on the lower surface of the fixing plate 53. A lower end portion of each of the four fixing tools 54 is connected with an upper surface of the first upper plate 12, and the outer tube 52 is thereby fixed to the first housing portion 11.

As illustrated in FIG. 6, a hole slightly larger than an outer diameter of the inner tube 55 is provided to a general central portion of the fixing plate 53, and the inner tube 55 is caused to pass through the hole. The inner tube 55 is inserted in the outer tube 52 to be capable of extension and contraction. An upper end portion of the inner tube 55 does not enter the outer tube 52 but is always exposed in extension and contraction of the inner tube 55 relative to the outer tube 52, and an inner tube connection portion 56 is provided to the upper end portion of the inner tube 55. The ball joint 61 is connected with the inner tube connection portion 56.

The ball joint 61 has a ball stud 62 as a rod-shaped member which is connected with the inner tube 55 and a socket 66 which is fixed to the first support plate 47 and in which an upper end portion of the ball stud 62 is inserted. The ball stud 62 has a rod-shaped portion 63 as a rod-shaped member formed to have a uniform outer diameter, a connection portion 65 provided to a lower end portion of the rod-shaped portion 63, and a spherical portion 64 provided to an upper end portion of the rod-shaped portion 63. The connection portion 65 is connected with the inner tube connection portion 56 by screw fitting.

On a back side of the first support plate 47, the socket 66 is arranged in a position directly above each of the inner tubes 55. The socket 66 is formed to have an inner diameter slightly larger than the spherical portion 64 and is formed into a cylindrical shape in which an upper side is blocked and lower side is open. A resin member, not illustrated, which has a recessed shape corresponding to the spherical portion 64 and whose lower side is open, is inserted in an internal portion of the socket 66 and retains the spherical portion 64 while enfolding that. As known, when an angle formed between the ball stud 62 and the first support plate 47 changes, the spherical portion 64 relatively rotates while sliding on an inner surface of the resin member without changing a center position in an internal portion of the resin member.

In accordance with the acceleration signal from a cabin of the work machine which is remotely operated, the first up-down direction driving units 51, 51 and the second up- down direction driving unit 57 move upward and downward the inner tubes 55 inserted in the outer tubes 52, cause the lower surface of the first support plate 47 to move upward and downward, and thereby cause the seat device 40 to move upward and downward. A driving source of the first up-down direction driving units 51, 51 and the second up-down direction driving unit 57 is not illustrated but is an air pressure produced by an air pump or an electric motor, for example. In a case of the air pressure, the air pressure is introduced into a stroke space of the inner tube 55 in an internal portion of the outer tube 52, a lower end portion of the inner tube 55 is pressed, and the inner tube 55 thereby extends and contracts relatively to the outer tube 52. Further, in a case of the electric motor, a gear tooth surface is continuously provided to an outer circumferential surface of the inner tube 55 in a longitudinal direction, a rack gear is thereby formed, and the electric motor in which a pinion gear is provided to an output shaft is provided in the first housing portion 11. The pinion gear of the electric motor meshes with the gear tooth surface of the inner tube 55 through a hole of the outer tube 52 and is driven, and the inner tube 55 thereby extends and contracts relatively to the outer tube 52.

The first up-down direction driving units 51, 51 and the second up-down direction driving unit 57 are capable of mutually independently controlling extension-contraction positions of the inner tubes 55 relative to the outer tubes 52. For example, as in FIG. 3 and FIG. 4, respective upper end positions of the inner tubes 55 of the first up-down direction driving units 51, 51 and the second up-down direction driving unit 57 are capable of being controlled to the same height. In such a case, the ball stud 62 becomes generally perpendicular to the first support plate 47, and the first support plate 47 is horizontally retained.

Further, the respective upper end positions of the inner tubes 55 of the first up-down direction driving units 51, 51 and the second up-down direction driving unit 57 are capable of being controlled to different heights. For example, as in FIG. 2, in a case where the upper end positions of both of the inner tubes 55 of the first up-down direction driving units 51, 51 are set lower than the upper end position of the inner tube 55 of the second up-down direction driving unit 57, the ball studs 62 are, relatively to the first support plate 47. at slightly inclined angles compared to a perpendicular direction, and in this state, the first support plate 47 is retained. In this case, the spherical portion 64 smoothly slides on the socket 66, and the first support plate 47 is retained while following the upper end position of each of the inner tubes 55.

Further, the first up-down direction driving units 51, 51 and the second up-down direction driving unit 57 vibrate the seat device 40 based on the acceleration signal of the cabin, which is transmitted from the work machine. In a case where the seat device 40 is vibrated, the respective inner tubes 55 of the first up-down direction driving units 51, 51 and the second up-down direction driving unit 57 are caused to mutually independently and little by little move upward and downward in short times. When each of the inner tubes 55 is little by little moved upward and downward, the spherical portion 64 and the socket 66 smoothly slide on each other, and the first support plate 47 moves upward and downward smoothly in response to motions of each of the inner tubes 55. As a result, the seat device 40 can be vibrated.

Next, a description will be made about the rotation direction driving unit 71 as a mechanism which rotates the seat device 40. The rotation direction driving unit 71 has a driving force production device 72 which produces a driving force for rotating the seat device 40 and a driving force transmission unit 73 which transmits the produced driving force. The driving force production device 72 is a linear driving device, is formed into a rectangular cuboid shape, and is provided to an upper surface of a rear end portion of the first support plate 47. A driving form of the linear driving device is not limited but is a linear motor, for example. As other cases of the driving form of the linear driving device, an air cylinder or a combination of a rotating motor and a ball screw may be used. The driving force transmission unit 73 is fixed to an output unit of a driving force production device 72 and is coupled with a rear end portion of the second support plate 48 which is rotatably retained. When the driving force production device 72 moves in a linear direction, the driving force transmission unit 73 integrally moves. Accordingly, the second support plate 48 moves in response to the motion, and the seat portion 41 and the backrest portion 42 which are fixed to the second support plate 48 rotate. Similarly to the up-down direction, the rotation direction driving unit 71 produces a rotational force in accordance with the acceleration signal of the cabin, which is transmitted from the work machine to be remotely operated.

In the following, a description will be made about an action in each mode provided to the remote control device 100 with reference to FIG. 2 to FIG. 4. The remote control device 100 has the getting on-off mode illustrated in FIG. 2, a standby mode illustrated in FIG. 3, and an operation mode illustrated in FIG. 4.

### (1) Getting On-off Mode

FIG. 2 is a side view illustrating the remote control device 100 in the getting on-off mode state. Because the seat device 40 is retained at a predetermined height in the remote operation and it is difficult for the operator to get on and off, the getting on-off mode serves as a mode for the operator to easily get on and off the seat device 40. In the getting on-off mode, the upper end positions of both of the inner tubes 55 of the first up-down direction driving units 51, 51 are controlled to lower positions than the upper end positions in the standby mode and the operation mode, which will be described later, and the upper end position of the inner tube 55 of the second up-down direction driving unit 57 is controlled to a higher position than the upper end position in the standby mode and the operation mode.

Thus, compared to the standby mode and the operation mode, in the getting on-off mode, a front end position of the first support plate 47 is retained to be low, and a rear end position is retained to be high. As a result, the first support plate 47 is retained in a state where that is inclined to a front side, the seat portion 41 and the backrest portion 42 are inclined forward compared to the standby mode and the operation mode. Further, the seat portion 41, the backrest portion 42, the armrests 43, and the foot retainment portion 44 are positioned close to the second upper plate 16 of the first housing portion 11 which is the floor. In addition, a lower surface of the second foot retainment member 46 of the foot retainment portion 44 is in contact with the second upper plate 16.

When the operator gets on the remote control device 100, the operator gets on the second upper plate 16 of the second housing portion 15, steps on the second foot retainment member 46 which is in contact with the first upper plate 12, and is seated on the seat portion 41. Because the lower surface of the second foot retainment member 46 is in contact with the second upper plate 16, a body weight of the operator is supported by a floor surface.

Regarding to the above embodiment, a first modification will be described. In the above, about a position of the upper end portion of each of the inner tubes 55 in the getting on-off mode, a description is made about a case where the upper end positions of both of the inner tubes 55 of the first up-down direction driving units 51, 51 are controlled to lower positions than the upper end positions in the standby mode and the operation mode and the upper end position of the inner tube 55 of the second up-down direction driving unit 57 is controlled to a higher position than the upper end position in the standby mode and the operation mode. As a modification about this point, while the upper end positions of both of the inner tubes 55 of the first up-down direction driving units 51, 51 are set as described above, control may be performed such that the upper end position of the inner tube 55 of the second up-down direction driving unit 57 is not changed from the upper end position in the standby mode and the operation mode and is set to the same height position. In a case where such control is performed, control of the first up-down direction driving units 51, 51 and the second up-down direction driving unit 57 can be simplified. Further, an up-down direction stroke range of the second up-down direction driving unit 57 becomes small, it thereby becomes possible to select the second up-down direction driving unit 57 which has a small up-down direction stroke amount and is more inexpensive, and this contributes to cost reduction.

Regarding to the above embodiment, a second modification will be described. In the above, a description is made about a configuration in which in the getting on-off mode, the seat portion 41, the backrest portion 42, the armrests 43, and the foot retainment portion 44 come close to the floor, but a configuration is possible in which only the foot retainment portion 44 comes close the floor. A basic structure of the present second modification is the same as the above, and a configuration in which the first up-down direction driving units 51, 51 and the second up-down direction driving unit 57 vibrate the seat device 40 is similar to the above description. Meanwhile, in the getting on-off mode, the first up-down direction driving units 51, 51 and the second up-down direction driving unit 57 do not move upward or downward, the seat portion 41, the backrest portion 42, the armrests 43, and the foot retainment portion 44 maintain the height in the standby mode and the operation mode, and only the foot retainment portion 44 comes close the floor. Alternatively, the foot retainment portion 44 is set to a position in contact with the floor.

For example, the foot retainment portion 44 is configured to be driven by a motor. which is not illustrated, and to rotate around a connection portion with the second support plate 48 as a center. An end portion of the first foot retainment member 45 is connected via a rotation shaft which is not illustrated and which is arranged between the above end portion and an end portion of the second support plate 48 and is parallel with the left-right direction. The rotation shaft is driven by a motor which is not illustrated. In the getting on-off mode, the foot retainment portion 44 is driven by the motor and moves to a position in which the second foot retainment member 46 is positioned close to the floor or a position in contact with the floor. In the standby mode and the operation mode, the foot retainment portion 44 is driven by the motor, thereby moves to a position which is upward spaced apart from the floor, and is retained in the position. In the present second modification, because the first up-down direction driving units 51, 51 and the second up- down direction driving unit 57 are used only for reproducing vibration, stroke amounts of the first up-down direction driving units 51, 51 and the second up-down direction driving unit 57 can be made small. As a result, control of the first up-down direction driving units 51, 51 and the second up-down direction driving unit 57 is simplified, and the first up-down direction driving units 51, 51 and the second up-down direction driving unit 57, which have small stroke amounts and are more inexpensive, can thereby be employed.

### (2) Standby Mode

FIG. 3 is a side view illustrating the standby mode state. The standby mode is a mode for preparing for a transition to the operation mode by setting the seat device 40 to a predetermined height and for leaving the operation mode in a case where a predetermined condition is detected in the operation mode. When the operator gets on the remote control device 100 and the predetermined condition is satisfied, a transition is performed to the standby mode. The predetermined condition is either one of a case where application software of the remote control device 100 is started by a predetermined operation and a case where a mode switching switch is operated which is not illustrated and which switches a getting on-off state and a standby state.

When a transition is performed to the standby mode, the upper end positions of both of the inner tubes 55 of the first up-down direction driving units 51, 51 and the upper end position of the inner tube 55 of the second up-down direction driving unit 57 are controlled to predetermined height positions, and the first support plate 47 is retained in a horizontal state. In the standby mode, a height at which the first support plate 47 is retained is the same as that in the operation mode, but in the standby mode, the following is different from the operation mode. In the standby mode, the remote control device 100 does not accept an operation of the work machine by the operator. Further, vibration of the cabin of the work machine which is remotely operated is not transmitted to the seat device 40.

### (3) Operation Mode

FIG. 4 is a side view illustrating the remote control device 100 in the operation mode state. The operation mode is a mode in which the remote operation of the work machine is performed. In the standby mode, in a case where the remote control device 100 detects a predetermined condition on which it is determined that the operator has an intention of switching to the operation mode, a transition is performed to the operation mode. The predetermined condition for the transition to the operation mode includes a condition about an action state of a device included in the work machine, a condition about a visual recognition state of the operator, and a condition about a state of a stop switch. A height position and a posture of the seat device 40 in the operation mode are not changed from the standby mode and are the same.

The condition about the action state of the device included in the work machine is a condition which indicates whether the operator attempts to perform the remote operation of the work machine and sets the work machine, which is remotely operated, to an action starting state. For example, a lock state of a hydraulic device for work such as a shovel included in the work machine is raised. When the operator releases a lock of the hydraulic device for work, it is assessed that the operator has intent to perform the remote operation of the work machine. Another case of the condition about the action state of the device included in the work machine may be a case where the operator turns on an engine of the work machine, which is remotely operated, by operating an operation switch on an operation panel, which is not illustrated. In addition, another case may be a case where the operator turns on an electromotor for travel or an electromotor for a work device of the work machine, which is remotely operated, and establishes the action state by operating an operation switch on the operation panel, which is not illustrated. In those cases, it is assessed that the operator has intent to perform the remote operation. Note that at a time point when a transition is performed from the getting on-off mode to the standby mode, the hydraulic device for work is set to a lock state, and the engine of the work machine, the electromotor for travel, and the electromotor for the work device are turned off.

The condition about the visual recognition state of the operator is a condition which indicates whether the operator is in a state where he/she attempts to perform the remote operation of the work machine and carefully visually recognizes the monitor device 20. The monitor device 20 includes the image-capturing device 24 which captures an image of the operator, and the visual recognition state of the operation is detectable. The remote control device 100 detects whether the operator directly views the monitor device 20. In a case where it is detected that the operator does not directly view the monitor device 20 but looks aside, a transition is not performed to the operation mode. As for a determination about whether the operator directly views the monitor device 20, it may be determined that the operator directly views the monitor device 20 when in a top view, a face of the operator is directed in an angle range between both end portions of the left and right monitors. For example, in a top view of the face of the operator, when a direct front is set as 0 [deg], a range of 30 [deg] or a range of 45 [deg] can be set for each of left and right.

The condition about the state of the stop switch is a condition about an operation state of a switch for stopping the remote operation, the switch being included in the remote control device 100. In a case where the operator operates an emergency stop switch for ceasing the remote operation for some reasons, a transition is not performed to the operation mode.

When the operator does not look aside, the emergency stop switch is not operated, and the lock of the hydraulic device for work is released, the remote control device 100 automatically transits to the operation mode. Alternatively, the above condition for the transition to the operation mode may appropriately be changed. For example, in a case where either one of a state where the operator does not look aside and a state where the emergency stop switch is not operated and release of the lock of the hydraulic device for work are detected, the remote control device 100 may automatically transit to the operation mode.

Further, in the operation mode, the seat device 40 is vibrated by the first up-down direction driving units 51, 51 and the second up-down direction driving unit 57 in accordance with the acceleration signal from the work machine which is remotely operated. As indicated by arrows in FIG. 4, the driving device 50 drives and vibrates the seat device 40 in accordance with motions of the work machine during the remote operation, and the seat device 40 moves upward and downward in a transition from the getting on-off mode to another mode or a transition from the other mode to the getting on-off mode.

In the operation mode, when the remote control device 100 detects a predetermined condition while the work machine is remotely operated, a transition is automatically performed from the operation mode to the standby mode. The predetermined condition for the transition from the operation mode to the standby mode is a case where the lock state of the hydraulic device for work is detected, a case where it is detected that the operator looks aside, and a case where an operation of the emergency stop switch by the operator is detected. Alternatively, the predetermined condition may be a case where the operator turns off the engine of the work machine, which is remotely operated, by the operation switch on the operation panel, which is not illustrated. Alternatively, the predetermined condition may be a case where the operator turns off the electromotor for travel or the electromotor for the work device of the work machine, which is remotely operated, and establishes the non-action state by an operation switch on the operation panel, which is not illustrated. In those cases, it is assessed that the operator does not have intent to perform the remote operation. When at least one of those is detected, a transition is automatically performed from the operation mode to the standby mode.

When the remote operation is finished, a predetermined operation is detected, a transition is thereby performed from the standby mode to the getting on-off mode, and the operator gets off the remote control device 100 and finishes the remote operation. The predetermined operation for the transition from the standby mode to the getting on-off mode is either one of detection of an operation for finishing the application software of the remote control device 100 and detection of an operation of the mode switching switch for switching the getting on-off state and the standby state.

A remote control device according to the present invention includes: an operation mode which accepts an operation of a machine by an operator; and a getting on-off mode which is for the operator to get on and off a seat device, and in the getting on-off mode, at least a part of the seat device is positioned closer to a floor compared to the operation mode. In the present invention having the above specific configuration, a remote control device can be provided which is easy to get on and off, enables getting on and off without having a firm foot retainment portion, and can be remotely operated safely and efficiently.

In the remote control device according to the present invention, a sense of riding can easily be given to the operator because the seat device is in a position apart from the floor in the operation mode, at least the part of the seat device comes close to the floor in the getting on-off mode, the operator thereby easily moves between the floor and the seat device, and the seat device which is easy to get on and off can be obtained.

The seat device of the remote control device according to the present invention preferably has a foot retainment portion which is for a foot of the operator to be placed, and in the getting on-off mode, the part of the seat device which comes close to the floor preferably includes the foot retainment portion.

In the remote control device according to the present invention, because when the operator gets on and off the seat device, the foot retainment portion which is for the foot to be placed is lowered and comes close to the floor, movement of feet by the operator between the floor and the foot retainment portion becomes easy, and the seat device which is easier to get on and off can be obtained.

In the remote control device according to the present invention, in the getting on-off mode, at least a part of the foot retainment portion is preferably in contact with the floor.

In the remote control device according to the present invention, because the foot retainment portion is in contact with the floor in the getting on-off mode, the body weight of the operator, which is exerted on the foot retainment portion when the operator gets on and off the seat device, can be supported by the floor. Thus, without having the firm foot retainment portion, the remote control device which is easy to get on and off can be obtained.

In the remote control device according to the present invention, the seat device preferably has a seat portion, and in the getting on-off mode, at least the seat portion of the seat device is preferably inclined forward compared to the operation mode.

In the remote control device according to the present invention, because the seat portion of the seat device is inclined forward in the getting on-off mode, the operator does not have to deeply sit into the seat portion when he/she is seated on the seat portion, and the seat device which is easier to get on and off can be obtained. Further, because the seat portion of the seat device is in a forward inclined state, it can immediately be perceived that the seat device is in the getting on-off mode when that is visually observed from a periphery. Thus, without checking whether the getting on-off mode is selected, the operator can get on the seat device. Consequently, the remote control device which is easy to get on and off can be obtained.

The remote control device according to the present invention preferably further includes a standby mode which does not accept an operation of the machine.

Because the remote control device according to the present invention includes the standby mode, when the operator is not conscious of performing the remote control of the machine, the operator can be prevented from unintentionally operating the machine.

When either one of the operation mode and the standby mode is selected, the remote control device according to the present invention preferably performs switching to the other mode in a case where the remote control device detects a predetermined condition.

In the remote control device according to the present invention, because the operation mode and the standby mode can be switched in accordance with a situation, an optimal action mode can be selected in accordance with the situation. Further, forgetting to perform switching can be prevented. Consequently, the remote control device which can efficiently perform the remote operation can be obtained.

In the remote control device according to the present invention, the predetermined condition for switching the operation mode and the standby mode preferably includes a condition about an action state of a device included in the machine to be operated.

In the remote control device according to the present invention, an optimal operation mode can be selected in accordance with the state of the machine to be operated. For example, in a case where the machine is the work machine, a condition about the lock state of the hydraulic device for work included in the work machine can be included. For example, the standby mode can automatically be selected when a hydraulic lock state of the work device of the work machine is detected, and the operation mode can automatically be selected when a hydraulic lock released state is detected. Consequently, the remote control device can be obtained which can prevent an action not intended by the operator and can safely and efficiently perform the remote operation.

In the remote control device according to the present invention, the predetermined condition for switching the operation mode and the standby mode preferably includes a condition about a visual recognition state of the operator.

In the remote control device according to the present invention, in a case where the visual recognition state of the operator is not a proper state, for example, when the operator looks aside without viewing the monitor, switching to the standby mode can automatically be performed. Consequently, a work failure due to an operation failure of the operator can be prevented.

The remote control device according to the present invention preferably includes a driving device which drives the seat device in accordance with a motion of a machine in a remote operation, and a transition from the getting on-off mode to another mode or a transition from another mode to the getting on-off mode is preferably performed by driving the seat device by the driving device.

In the remote control device according to the present invention, mode switching for the seat device can be performed by the driving device which vibrates the seat device. Consequently, without having a driving device dedicated to the mode switching for the seat device, vibration of the seat device and the mode switching can be performed with minimum devices and costs.

In the remote control device according to the present invention, the seat device is preferably fixed to a housing, and an upper surface of the housing preferably forms the floor.

In the remote control device according to the present invention, because the remote control device includes the housing whose upper surface forms the floor, a state of the floor can be maintained constant by utilizing the flat upper surface of the housing regardless of an installation place of the remote control device, and the remote control device can be obtained in which walking is easy and which is easy to get on and off. The housing can be used for usage of housing electronic apparatuses including an arithmetic processing unit which performs processes for the whole remote control device, for example.

### REFERENCE SIGNS LIST

10 housing

40 scat device

41 seat portion

44 foot retainment portion

50 driving device

100 remote control device

1. A remote control device including a seat device and operating a machine by a remote operation, the remote control device comprising:
an operation mode which accepts an operation of the machine by an operator; and
a getting on-off mode which is for the operator to get on and off the seat device, wherein
in the getting on-off mode, at least a part of the seat device is positioned closer to a floor compared to the operation mode.

2. The remote control device according to claim 1, wherein
the seat device has a foot retainment portion which is for a foot of the operator to be placed, and
in the getting on-off mode, the part of the seat device which comes close to the floor includes the foot retainment portion.

3. The remote control device according to claim 2, wherein
in the getting on-off mode, at least a part of the foot retainment portion is in contact with the floor.

4. The remote control device according to claim 1, wherein
the seat device has a seat portion, and
in the getting on-off mode, at least the seat portion of the seat device is inclined forward compared to the operation mode.

5. The remote control device according to claim 1, further comprising
a standby mode which does not accept an operation of the machine by the operator.

6. The remote control device according to claim 5, wherein
when in either one of the operation mode and the standby mode, the remote control device performs switching to the other mode in a case where the remote control device detects a predetermined condition.

7. The remote control device according to claim 6, wherein
the predetermined condition includes a condition about an action state of a device included in the machine.

8. The remote control device according to claim 6, wherein
the predetermined condition includes a condition about a visual recognition state of the operator.

9. The remote control device according to claim 1, wherein
the remote control device includes a driving device which drives the seat device in accordance with a motion of the machine during the remote operation, and
a transition from the getting on-off mode to another mode or a transition from another mode to the getting on-off mode is performed by driving the seat device by the driving device.

10. The remote control device according to claim 1, wherein
in the remote control device, the seat device is fixed to a housing, and an upper surface of the housing forms the floor.
